(19) United States
(12) Patent Application Publication
(10) Pub. No.: US 2012/0270031 A1
(43) Pub. Date: Oct. 25, 2012

(54) POROUS MATERIALS COATED WITH CALCIUM PHOSPHATE AND METHODS OF FABRICATION THEREOF

(75) Inventors: Limin Guan, Toronto (CA); John E. Davies, Toronto (CA)

(73) Assignee: REGENERATION THERAPEUTIC INC., Toronto, ON (CA)

(21) Appl. No.: 13/498,844

(22) PCT Filed: Sep. 28, 2010
(86) PCT No.: PCT/CA2010/001499

§ 371 Date: Jul. 5, 2012

(30) Foreign Application Priority Data
Sep. 28, 2009 (US) 12585899

(51) Int. Cl. B05D 7/22; B32B 3/26; C08L 67/04; B32B 37/24

(52) U.S. Cl. 428/312.8; 427/230; 156/242; 521/182

(57) ABSTRACT

The present invention relates to a method of coating a porous material such as a medical implant with a layer of calcium phosphate, wherein the material is submersed in an aqueous solution of calcium, phosphate and carbonate ions, and the pH of the solution is gradually increased. A calcium phosphate coating is formed on an internal surface of the porous material by agitating the solution during coating formation.

### CROSS-REFERENCE TO RELATED APPLICATION

This application claims priority to U.S. patent application Ser. No. 12/585,899, titled “METHOD OF FORMING AN APATITE COATING WITHIN A POROUS MATERIAL” and filed on Sep. 28, 2009, the entire contents of which are incorporated herein by reference.

### FIELD OF THE INVENTION

This invention relates to methods of coating medical implants for improved biocompatibility and bone adhesion. More particularly, the present invention relates to methods of internally coating porous medical implants with a calcium phosphate layer.

### BACKGROUND OF THE INVENTION

Calcium phosphate coatings are well known to improve the biocompatibility of implantable medical devices by allowing for the ingrowth of natural bone into and around the device. The coating supports the formation of chemical bonds between the device and natural bone, thus dramatically improving the osteoconductivity of implanted devices such as bone prosthesis and dental implants. Moreover, these coatings have been reported to eliminate the early inflammatory responses provoked by polymeric implants or polymer covered implants (e.g. PLGA). Such benefits can be further enhanced by incorporating bioactive materials during the formation of the coating.

Early coating methods suffered from a number of drawbacks that have limited their clinical effectiveness and use. For example, the electrophoresis method, while providing a low-temperature process, suffers from low bond strength and typically requires an additional post-process sintering step. While the plasma spray method provides a coating with a high bond strength, the high temperatures required for the process results in the decomposition of the coating and limit the number of substrates that may be used (e.g. plasma spraying is incompatible with most polymer substrates). Furthermore, line-of-sight processes such as the plasma spray process suffer from very poor infiltration of porous materials.

More recently, biomimetic methods have sought to overcome many of these drawbacks by providing a low-temperature process involving an aqueous environment that is designed to simulate or approximate natural biological conditions. Initial biomimetic approaches employed low-concentration simulated body fluid (SBF), which was typically prepared having very low calcium and phosphate concentrations that mimic the natural concentrations of these ions on the body (e.g. typically about 2.5 mM and 1.0 mM, respectively, for 1×SBF [1]). In such low concentration SBF methods, the pH of the coating solution was usually adjusted to a value of about 7.4 using buffering agents, such as TRIS [2] or HEPES [3].

Unfortunately, such methods often required incubation periods exceeding three to four weeks for the formation of a suitable layer of calcium phosphate on a substrate, with frequent changes of the coating solution. In order to decrease the coating time for the process, many sought to increase the ionic concentration of the aqueous environment to levels many times that of SBF.

Barrere et al. [6-8] achieved this goal by providing a process employing a 5×SBF solution (with an initial pH value close to 5.8) that required only hours to form a coating on a substrate. The method also provided the benefit of not requiring any buffering agent, such as TRIS or HEPES. Two coating solutions were employed in the process, and pH was increased to higher values to achieve nucleation of calcium phosphate by bubbling CO₂ gas into the reaction chamber. Using such a process, coating thicknesses in the range of tens of millimeters were achieved after 6 h of immersion and incubation.

A similar method is disclosed in Japanese Patent Application No. 08040711, which teaches a process of forming a calcium phosphate coating, in which carbon dioxide gas is passed through a SBF solution to dissolve calcium phosphate and aid in the formation of the coating. In this known process, sodium hydroxide is present in the calcifying solution, which significantly increases the pH. As a result, a high pressure of carbon dioxide is needed in order to obtain a low enough pH to dissolve sufficient calcium phosphate.

U.S. Pat. Nos. 6,207,218 (Layrolle, 2001), 6,733,503 (Layrolle, 2004), and 6,994,883 (Layrolle, 2006) also describe a biomimetic method in which an implant is submersed in an aqueous solution of magnesium, calcium and phosphate ions through which a gaseous weak acid is passed. The solution is subsequently degassed, which raised the pH, and the coating is allowed to precipitate onto the implant (some growth factors can be also incorporated into the coating via this process).

Such advancements clearly improve over previous 1×, 1.5× and 2.×SBF biomimetic coating methods by providing new methods that require less incubation time and less coating solution, but still suffer from the disadvantage of requiring an extra gas supply. Furthermore, the initially low pH of the coating solution (e.g. 5.2) may denature some growth factors intended to be incorporated into the coating.

An improved method was disclosed in U.S. Pat. No. 6,569,489 (Li, 2003), in which a calcium phosphate coating is formed without the need for bubbling carbon dioxide gas though the aqueous coating solution. The method instead relies on the addition of bicarbonate ions to a high-concentration SBF coating liquid, which interact with the atmosphere above the liquid interface to raise the pH of the solution for the formation of a calcium phosphate layer on a substrate. However, the process as taught requires the control of the partial pressure of carbon dioxide in the atmosphere above the liquid, which increases the complexity of the process. Similar methods were subsequently disclosed in U.S. Patent Application No. US2003/0113438 (Liu, 2007) and a publication by Tas et al. [9].

While the above methods provide rapid, low-temperature methods of producing a calcium phosphate coating on a medical device, they are static methods that are optimized for the coating of medical devices having a solid substrate as opposed to implants exhibiting a porous internal structure. Furthermore, depending on the selected ionic concentration and the coating rate, the coating may not be evenly distributed along the substrate surface.

The inability of such prior art methods to internally coat porous structures is particularly evident in Li (U.S. Pat. No. 6,659,489), which suggests that the method disclosed is only adapted to shallow porous structures. For example, Li discloses that the method is suitable for use in coating porous undercut and recessed surfaces. However, porous undercut structures and recessed surfaces are locally porous, with porosity that does not extend deep into the implant or device. Furthermore, Li discloses that the method can be applied to porous beaded substrates. However, porous beaded structures are obtained by sintering a powder onto a solid surface, thereby producing a shallow, locally-porous shell on an otherwise solid material.

The methods described above, and particularly the method disclosed by Li, are thus only static methods that are adapted to shallow porous or recessed features, rather than deep porosity or porosity extending throughout the volume of the structure. What is therefore needed is an improved method of coating porous materials that enables the efficient and homogenous coating within porous materials.

### SUMMARY OF THE INVENTION

The present invention provides a simple method for coating the internal surface of a porous material, such as a medical implant, with a layer of calcium phosphate. A porous material is submerged or contacted with an aqueous solution that contains calcium ions, phosphate ions, and carbonate ions. The pH of the solution is allowed to gradually rise, during which time the solution is agitated, thereby enabling the formation of a calcium phosphate layer internally within the porous material.

In a first aspect, there is provided a method of forming a calcium phosphate coating on internal surface of a porous material, the method comprising the steps of: providing an aqueous solution comprising calcium ions, phosphate ions, and carbonate ions, wherein the aqueous solution has a temperature less than approximately 100° C. and an initial pH in a range of approximately 6.0 to 7.5; contacting the porous material with the solution; and agitating the solution while forming the calcium phosphate coating on the internal surface of the porous material. The solution is preferably agitated at a speed of approximately 50-1000 revolutions per minute, and more preferably approximately 200-400 revolutions per minute. The calcium phosphate coating is preferably hydroxyapatite.

The step of agitating the solution is provided for increasing a rate of change of the pH of the solution by increasing a rate of extraction of carbon dioxide gas from the solution to an atmosphere above the solution, and the rate of change of pH of the solution is preferably selected by controlling the step of agitating of the solution.

The carbonate ions may be provided by adding a quantity of sodium bicarbonate to the solution, and the carbonate ions are preferably present with a concentration in the range of approximately 1-50 mM. The calcium ions are preferably present with a concentration in the range of approximately 1-50 mM and the phosphate ions are present with a concentration in the range of approximately 1 to 25 mM. The temperature of the solution is preferably controlled within a range of approximately 20° C. to 50° C.

The aqueous solution may comprise additional ionic species selected from the group consisting of sodium, magnesium, chlorine, potassium, sulfate, silicate and mixtures thereof. The sodium ions are preferably present with a concentration in the range of approximately 100 to 1000 mM, the chlorine ions are present with a concentration in the range of approximately 100 to 1000 mM the potassium ions are present with a concentration in the range of approximately 1 to 10 mM, the magnesium ions are present with a concentration in the range of approximately 0.1 to 10 mM.

A thickness of the calcium phosphate coating may be selected by controlling a parameter selected from the group consisting of temperature, mixing rate, concentrations of ionic species, and any combination thereof. The step of agitating the solution is preferably performed until a thickness of the calcium phosphate coating is obtained in the range of approximately 0.5 to 50 microns.

The aqueous solution may further comprise a bioactive material and the bioactive material is incorporated into the calcium phosphate coating.

The porous material preferably comprises a connected network of macropores, and the average diameter of the macropores is preferably greater than approximately 200 microns.

The porous material preferably comprises a composite material formed of a macroporous polymer scaffold and calcium phosphate particles. The macroporous polymer scaffold may comprise an essentially non-membraneous pore walls, the pore walls consisting of microporous polymer struts defining macropores which are interconnected by macroporous passageways, the microporous polymer struts containing calcium phosphate particles dispersed therethrough and a binding agent for binding the calcium phosphate particles to a polymer making up the macroporous polymer scaffold, microporous passageways extending through the microporous polymer struts so that macropores on either side of a given microporous polymer strut are in communication through the given microporous polymer strut. The macroporous polymer scaffold preferably comprises with macropores a mean diameter in a range from about 0.5 to about 3.5 mm, and the macroporous polymer scaffold has a porosity of at least 50%.

The porous material may comprise a material with a porous surface layer coating a solid support. The material with a porous surface layer may be a beaded substrate or a porous undercut.

The solution is preferably provided in a vessel comprising an opening with a size selected to obtain a desired rate of change of the pH. A ratio of a surface area of an interface between the solution and an atmosphere above the solution to an area of the opening is preferably in the range of approximately 2000-5000.

A concentration of hydrochloric acid may be added to the solution prior to contacting the porous material with the solution. The concentration of hydrochloric acid in the solution is preferably in the range of approximately 1-25 mM.

The method according to any one of claims 1 to 25, wherein the porous material comprises an internally connected porous network, the network defined substantially throughout the material.

The porous material may comprise a plurality of porous particles. The porous particles may be obtained by grinding a monolithic porous structure. An average size of the porous particles made for moldable material is preferably between approximately 250 microns and 20 mm. Alternatively, an average size of the porous particles made for injectable material is between approximately 45 microns and 250 microns.

The method may further comprise the step of separating the porous particles coated with calcium phosphate from the solution and mixing the porous particles coated with calcium phosphate with a carrier. The carrier is preferably selected from the group consisting of sodium alginate, gelatin, carboxymethyl cellulose, lecithin, glycerol, sodium hyaluronate, and pluronic F127.

A moldable porous material may be formed by adding a fluid to the porous particles coated with calcium phosphate and the carrier. The carrier is preferably provided with a weight percentage of approximately 10-20%. The fluid may be selected from the group consisting of water, sterilized water, physiological saline, blood and bone marrow aspirate. Approximately 1.5-3.0 ml of fluid are provided for each 1.0 gram of particles.

The porous material may be formed as a sheet, the method further comprising the steps of: forming a polymer film by casting a polymer solution; and adhering the sheet to a surface of the polymer film. The step of adhering the sheet to the surface of the film preferably comprises the step of contacting the sheet with the surface before the film has fully solidified. The polymer preferably comprises poly(lactide-co-glycolide) and/or polylactide. The solvent may be selected from the group consisting of acetone, chloroform, dichloromethane, ethyl acetate, and tetrahydrofuran. The porous material and the polymer film preferably comprise a common polymer.

In another aspect, there is provided a material comprising an internally connected porous network, the porous network defined substantially throughout the material, wherein pores forming the porous network are coated with a calcium phosphate layer. A thickness of the calcium phosphate layer is preferably in a range of approximately 0.5 to 50 microns. The layer may further comprise a bioactive material. The calcium phosphate layer is preferably hydroxyapatite.

The porous network preferably comprises a connected network of macropores, and an average diameter of the macropores is preferably greater than approximately 200 microns. The internally connected porous network may comprise a composite material formed of a macroporous polymer scaffold and calcium phosphate particles. The macroporous polymer scaffold may comprise essentially non-membraneous pore walls, the pore walls consisting of microporous polymer struts defining macropores which are interconnected by macroporous passageways, the microporous polymer struts containing calcium phosphate particles dispersed therethrough and a binding agent for binding the calcium phosphate particles to a polymer making up the macroporous polymer scaffold, microporous passageways extending through the microporous polymer struts so that macropores on either side of a given microporous polymer strut are in communication through the given microporous polymer strut. The macroporous polymer scaffold may comprise macropores a mean diameter in a range from about 0.5 to about 3.5 mm, and the macroporous polymer scaffold has a porosity of at least 50%.

In another aspect, there is provided a composite porous membrane according to the material described above, further comprising a polymer film, wherein the material is formed as a sheet and adhered to a surface of the polymer film. The polymer preferably comprises poly(lactide-co-glycolide) and/or polylactide, and the material and the polymer film preferably comprise a common polymer.

In yet another aspect, there is provided a mixture for forming a moldable porous material, the mixture comprising: a plurality of porous particles, each the porous particle comprising a calcium phosphate coated porous material as described above, and a carrier, wherein an addition of a fluid to the mixture forms the moldable porous material.

An average size of the porous particles made for moldable material is preferably between approximately 250 microns and 20 mm. Alternatively, an average size of the porous particles made for injectable material is between approximately 45 microns and 250 microns. The carrier may be selected from the group consisting of sodium alginate, gelatin, carboxymethyl cellulose, lecithin, glycerol, sodium hyaluronate, and pluronic F127. A weight percentage of the carrier is preferably approximately 10-20%. The mixture preferably comprises the aforementioned fluid for forming the moldable porous material. The fluid may be selected from the group consisting of water, sterilized water, physiological saline, blood and bone marrow aspirate.

A ratio of a volume of the fluid to a weight of the particles and carrier is preferably approximately 1.5-3.0 ml per 1.0 gram.

In another aspect, there is provided a method of forming a calcium phosphate coating on internal surface of a porous material comprising a composite material formed of a macroporous polymer scaffold and calcium phosphate particles, the method comprising the steps of: providing an aqueous solution comprising calcium ions, phosphate ions, and carbonate ions, wherein the aqueous solution has a temperature in a range of approximately 20° C.-50° C. and an initial pH in a range of approximately 6.0-7.5; contacting the porous material with the solution; and stirring the solution at a speed of approximately 200-400 revolutions per minute while forming the calcium phosphate coating on the internal surface of the porous material. The solution preferably comprises NaCl with a concentration in a range of approximately 200-800 mM, CaCl2.2H2O with a concentration in a range of approximately 7-14 mM, HCl with a concentration in a range of approximately 5-15 mM, Na2HPO4 with a concentration in a range of approximately 3-6 mM, and NaHCO3 with a concentration in a range of approximately 4-20 mM.

In another aspect, there is provided a material comprising an internally connected porous network, wherein pores forming the porous network are coated with a calcium phosphate layer by a method as described above.

A further understanding of the functional and advantageous aspects of the invention can be realized by reference to the following detailed description and drawings.

### BRIEF DESCRIPTION OF THE DRAWINGS

FIG. 1 shows the X-ray diffraction spectrum of the precipitate from the calcifying solution.

FIGS. 2 (a)-(c) shows scanning electron microscope images of the coated PLGA/CaP composite scaffold section at increasing magnification.

FIG. 3 shows scanning electron microscope images of the coated PEEK polymer surface at increasing magnification.

FIG. 4 shows histological images of the coated scaffold implanted in rat femur for 2 weeks. The samples were wax embedded and HE stained. FIG. 4(a) shows a field of view spanning 861 μm, while FIG. 4(b) shows a magnified view spanning 345 μm, and S represents the scaffold, C represents the coating and B stands for newly formed bone

FIG. 5 is a photo showing a moldable porous material handled by the surgical gloves.

FIG. 6 is a photo showing an injectable porous material extruded from a surgical syringe.

FIG. 7 shows photographs and SEM images of membrane surfaces, with (a) and (c) showing the PLGA+CaP porous side, and (b) and (d) showing the PLGA+CaP flat side. For images (a)-(c), the space between the lines is 1 mm. For images (c)-(d), the images are SEM images.

FIG. 8 provides images showing periodontal disease induction, where in (a), a surgically created periodontal defect is shown, (b) shows the impression material (at arrow) placed on the defect in the first surgery, and (c) shows an image 20 days after the first surgery, with the impression material (arrow) in the periodontal pocket.

FIG. 9 shows GTR surgical images (after membrane fixation), showing the PLGA+CaP (arrow) membrane.

FIG. 10 shows the progression of gingival recession in group A at (a) 11 days, (b) 30 days, and (c) 120 days.

FIG. 11 shows radiographs of group B, including (a) a control photograph prior to surgery, (b) immediately after GTR, (c) at 30 days and (d) at 120 days.

FIG. 12 provides microCT images of (a) OFD and (b) PLGA+CaP at 120 days.

FIG. 13 shows microCT images of (a) samples from the PLGA+CaP group (a) and (b), and OFD group (c) and (d) at 60 days. Arrows indicate the extent of bone buccal to the roots.

### DETAILED DESCRIPTION OF THE INVENTION

Generally speaking, the systems described herein are directed to a method of internally coating a porous material with a layer of calcium phosphate. As required, embodiments of the present invention are disclosed herein. However, the disclosed embodiments are merely exemplary, and it should be understood that the invention may be embodied in many various and alternative forms. The Figures are not to scale and some features may be exaggerated or minimized to show details of particular elements while related elements may have been eliminated to prevent obscuring novel aspects. Therefore, specific structural and functional details disclosed herein are not to be interpreted as limiting but merely as a basis for the claims and as a representative basis for teaching one skilled in the art to variously employ the present invention. For purposes of teaching and not limitation, the illustrated embodiments are directed to a method of internally coating a porous material with a layer of calcium phosphate.

As used herein, the terms, “comprises” and “comprising” are to be construed as being inclusive and open ended, and not exclusive. Specifically, when used in this specification including claims, the terms, “comprises” and “comprising” and variations thereof mean the specified features, steps or components are included. These terms are not to be interpreted to exclude the presence of other features, steps or components.

As used herein, the terms “about” and “approximately, when used in conjunction with ranges of dimensions of particles, compositions of mixtures or other physical properties or characteristics, is meant to cover slight variations that may exist in the upper and lower limits of the ranges of dimensions so as to not exclude embodiments where on average most of the dimensions are satisfied but where statistically dimensions may exist outside this region. It is not the intention to exclude embodiments such as these from the present invention.

As used herein, the coordinating conjunction “and/or” is meant to be a selection between a logical disjunction and a logical conjunction of the adjacent words, phrases, or clauses. Specifically, the phrase “X and/or Y” is meant to be interpreted as “one or both of X and Y” wherein X and Y are any word, phrase, or clause.

As used herein, the term “macroporous” means a porous material with an average pore diameter that is greater than approximately 10 microns in diameter, and the term “microporous” means a porous material with an average pore diameter that is less than approximately 10 microns in diameter.

As used herein, the term “calcium phosphate” generally refers to a group of phosphate minerals, including amorphous or crystalline hydroxyapatite (HA), β-tricalcium phosphate (TCP), tetracalcium phosphate (TTCP), dicalcium phosphate anhydrous (DCPA) or dicalcium phosphate dihydrate (DCPD), octacalcium phosphate (OCP).

As used herein, the term “porous” means having a material having pores or voids sufficiently large and sufficiently interconnected to permit passage of fluid.

As used herein, the term “agitation” may refer to any means of agitation of a liquid. Exemplary agitation methods include stirring, shaking, orbital mixing, magnetic mixing, vortexing and thermal convection.

In a preferred embodiment of the invention, a method is provided of forming a calcium phosphate coating on an internal surface of a porous material. The porous material preferably comprises a macroporous structure. The inventors have discovered that deeply nested surfaces within a material having an interconnected porous network may be effectively and uniformly coated with an apatatic layer by agitating a calcifying solution during the formation of a calcium phosphate layer. Unlike prior art methods, in which only shallow porous surfaces that are superficially coated with a calcium phosphate layer, embodiments of the present invention provide methods for coating the internally connected network of a porous material with a calcium phosphate layer. Additionally, complex shaped implants (such as porous or beaded surfaces) can be uniformly covered with a layer of calcium phosphate. As will be discussed in the following examples, the biocompatibility and osteoconductivity of such coated devices have been demonstrated by implantation in animal models.

Unlike prior art methods, embodiments of the present invention include the new and inventive step of agitating the calcifying solution during calcium phosphate layer formation to provide a rapid process for internally coating porous materials. The agitation enhances the flow of liquids into a porous structure, which replenishes the local ionic concentration within the pores. Without this replenishment, the local depletion of the ionic concentration would cause a decreased rate of calcium phosphate deposition internally within the porous material. The present inventors have discovered that agitation, preferably stirring or mixing with a mixing speed in the range of approximately 50-1000 revolutions per minute, and more preferably 200-400 revolutions per minute, enables the internal coating of pores extending deeply within or throughout the volume of a porous material.

In prior art methods, attempts to solve this problem have included frequent changing and replenishment of the calcifying solution, which has several drawbacks. A major drawback of changing the calcifying solution is this method is unable to achieve a satisfactory internal coating. Moreover, since this process typically must be done on a frequent basis, this complicates the process and makes it costly by consuming high volume of calcifying solution.

Embodiments of the present invention therefore provide a route to coat very complex porous structures rather than simply superficial porous coatings on an otherwise solid surface, and are adaptable to a wide range of low temperature, biomimetic-type processes employing a calcifying solution for the formation of an apatatic layer. The methods disclosed herein are particularly suited to the coating of medical implants such as porous scaffolds that contain a macroporous network of pores extending throughout their volume.

In a preferred embodiment, a porous material is internally coated by contacting the material with an aqueous calcifying solution comprising calcium, phosphate, and carbonate ions and agitating the solution during the nucleation, precipitation, and formation of calcium phosphate layer internally within the porous material.

The calcifying solution comprises a concentration of calcium and phosphate ions. The concentration of calcium ions is preferably in the range of approximately 1-50 mM, and more preferably in the range of about 7-14 mM. Calcium ions are preferably provided by dissolving a quantity of CaCl₂.2H₂O or CaCl₂ in an aqueous solution. The concentration of phosphate ions is preferably in the range of approximately 1-25 mM, and more preferably in the range of about 3-6 mM. Phosphate ions are preferably provided by dissolving a quantity of Na₂HPO₄ or Na₂HPO₄.2H₂O into the aqueous solution.

While embodiments of the present invention may be adapted to a wide range of methods involving the use of a calcifying solution for the formation of a calcium phosphate layer, it is particularly well suited to methods in which the pH of the calcifying solution is slowly raised to a level at which nucleation and precipitation are initiated. In one embodiment, the pH may be increased by bubbling carbon dioxide gas in the calcifying solution. In a preferred embodiment, the pH is raised by providing a concentration of bicarbonate ions that causes the release of carbon dioxide from the solution. The pH of the solution is preferably initially in the range of 6.0 to 7.5, and more preferably in the range of 6.2-6.8

Accordingly, in a preferred embodiment, carbon dioxide is produced in the solution by the reaction of bicarbonate ions. The carbon dioxide is gradually is released out of the solution while the solution is agitated, causing the pH of the calcifying solution to rise. The rise in the pH of the solution and the saturation of the solution is increased while agitating the solution until the nucleation of calcium phosphate crystals on the internal surfaces of the porous material (such as an implantable medical device) occurs. The nucleation layer deposits and subsequently grows on the internal surface of the porous material, forming a biocompatible and osteoconductive layer.

Preferably, the agitation of the solution is further employed to control the rate of release of carbon dioxide into the atmosphere above the solution, and to thereby control the rate of rinsing of pH within the solution.

Accordingly, the solution preferably includes a concentration of carbonate or bicarbonate ions in the range of approximately 1-50 mM, and more preferably 4-20 mM. As noted above, the concentration of carbonate ions is preferably provided by adding a quantity of sodium bicarbonate to the solution, which causes the pH of the solution to rise due to the formation and release of carbon dioxide.

The solution preferably further includes a concentration of HCl that is preferably added prior to the addition of a concentration of carbonate ions. A preferable concentration range of HCl is approximately 1-25 mM, and a more preferably range is 5-15 mM. HCl is preferably included to obtain an initial pH in the range disclosed above.

The calcifying solution may further comprise ions such as sodium, chlorine, potassium, sulfate, silicate and mixtures thereof. In a preferred embodiment, the calcifying solution comprises a concentration of Na and/or Cl ions in the range of approximately 100-1000 mM, and more preferably in the range of about 200-800 mM. Potassium ions may be provided with a concentration in the range of approximately 1-10 mM.

The calcifying solution is preferably maintained at a temperature of less than approximately 100° C., and more preferably between about 20° C. and 50° C.

The deposition rate and/or thickness of the apatitic coating can be adjusted by controlling one or more of many parameters. Such parameters include the temperature of the calcifying solution and the concentration of ions in the calcifying solution, particularly calcium, phosphate and carbonate. In a preferred embodiment, the contact time and/or immersion rate are selection to obtain a coating with a thickness in the range of 0.5-50 μm.

The coating rate is also dependent on the rate of change of pH of the solution, which can be controlled via the agitation speed or by controlling the partial pressure of carbon dioxide in the atmosphere above the solution. Specifically, the agitation rate can be employed to increase the rate of release of carbon dioxide gas from the solution, which increases the rate of change of pH within the solution. Preferably, the rate of change of pH, and accordingly, the deposition rate, is controlled by controlling the agitation speed from 100-800 rpm.

While prior art methods have required that the concentration of carbon dioxide in the atmosphere above the solution should be accurately controlled, the present inventors have found that a preferred deposition rate can be obtained by including an opening in the vessel that allows for the slow release of carbon dioxide gas. The opening is preferably millimeters in size. More preferably, the ratio of the surface area of the interface between the solution and the atmosphere above the solution to the area of the opening is in the range of approximately 2000-5000.

Coatings formed according to the embodiments disclosed herein may include biologically active agents such as growth factors, peptides, bone morphogenetic proteins, antibiotics, combinations thereof, and the like. In a preferred embodiment, bioactive agents as disclosed above are provided in solution and are co-precipitated and are thereby integrated into an apatatic layer within the porous structure.

Such integration of bioactive agents within a porous structure may result in the controlled release over a longer timescales then in prior art coating methods in which bioactive agents are primarily localized near the outer surface of a medical device. Furthermore, since embodiments of the present invention do not require the calcifying solution to be periodically changed or replenished, bioactive agents are effectively conserved and their loss from the process is minimized.

Embodiments of the present invention may be adapted for use with a wide variety of porous materials made of metal, ceramic, polymeric materials, silicon, glass, and the like suitable as medical implants. For example, suitable materials may include, but are not limited to, titanium, stainless steel, nickel, cobalt, niobium, molybdenum, aluminum, zirconium, tantalum, chromium, alloys thereof and combinations thereof. Exemplary ceramic materials include alumina, titania, and zirconia, glasses, and calcium phosphates, such as hydroxycalcium phosphate and tricalcium phosphate. Exemplary biodegradable polymeric materials include naturally occurring polymers such as cellulose, starch, chitosan, gelatin, casein, silk, wool, polyhydroxyalkanoates, lignin, natural rubber and synthetic polymers include polyesters such as polylactide (PLA), poly(glycolic acid) (PGA), poly(lactide-co-glycolide) (PLGA), poly(e-caprolactone) (PCL), poly(3-hydroxy butyric acid) (PHB) and its copolymers, polyvinyl alcohol, polyamide esters, polyanhydrides, polyvinyl esters, polyalkylene esters, polyurethanes, other biocompatible polymeric material, and the like. Exemplary non-degradable polymeric materials include poly(methyl methacrylate) (PMMA), polyaryletheretherketone (PEEK), polyethylene, polypropylene, polystyrene, polycarbonates.

The porous material to be coated with calcium phosphate according to the above embodiments, and those further described below, may possess any three dimensional shape, including, but not limited to, irregular particulates, cylinders, cubes, blocks, and wafers.

In a preferred embodiment, the porous structure is a polymer scaffold made from a polymer such as PLGA, as disclosed in U.S. Pat. No. 6,472,210, which is incorporated herein in its entirety. In a more preferred embodiment, the polymer scaffold is a composite polymer scaffold comprising a polymer such as PLGA and calcium phosphate particles. Such a composite scaffold structure is disclosed in U.S. Pat. No. 7,022,522, which is incorporated herein by reference in its entirety.

Accordingly, the method may be employed to internally coat the pores of a macroporous polymer scaffold that comprises essentially non-membraneous pore walls consisting of microporous polymer struts. The struts define macropores which are interconnected by macroporous passageways, and the microporous polymer struts contain calcium phosphate particles dispersed therethrough and a binding agent for binding said calcium phosphate particles to a polymer making up the macroporous polymer scaffold. The structure also preferably contains microporous passageways extending through the microporous polymer struts so that macropores on either side of a given microporous polymer strut are in communication through the given microporous polymer strut.

The macroporous polymer structure preferably includes a network of macropores a mean diameter in a range from about 0.5 to about 3.5 mm. Furthermore, the macroporous polymer scaffold preferably has a porosity of at least 50%.

In a preferred embodiment, such a composite porous material is internally coated with a calcium phosphate layer by contacting the material with an aqueous solution comprising calcium ions, phosphate ions, and carbonate ions, where the initial pH of the solution is in the range of about 6.2 to 6.8 and temperature of the solution is in the range of approximately 20° C. to 50° C. The solution is agitated during the formation of the apatite layer, thus enabling the solution to infiltrate the porous structure and deposit a calcium phosphate coating on internal surfaces of the porous material. The solution preferably comprises NaCl with a concentration in the range of approximately 200-800 mM, CaCl₂.2H₂O with a concentration in the range of approximately 7-14 mM, HCl with a concentration in the range of approximately 5-15 mM, Na₂HPO₄ with a concentration in the range approximately 3-6 mM, and NaHCO₃ with a concentration in the range of approximately 4-20 mM. In a preferred embodiment, the porous material is added after dissolving NaHCO₃ into the solution, i.e. after the initiation of a rise in pH due to the formation and release of carbon dioxide.

In a preferred embodiment, the porous composite material comprises a plurality of porous particles that are each coated with calcium phosphate. The particles may be freely introduced into the calcifying solution and subsequently extracted (after having formed a sufficiently thick layer of calcium phosphate) using a filtering or other separation step. In a preferred embodiment, the porous particles may be introduced into the calcifying solution by placing them in an open mesh container or bag (for example, a bag made of polyester or nylon mesh), where the size of the mesh openings is sufficiently small to contain the particles. For example, for particles with a size greater than about 200 microns, the mesh openings are less than 200 μm. The container or bag is then fully immersed into the coating solution and preferably immobilized within the container. Alternatively, if the particles have a size within the range of about 40-250 μm, then the mesh openings are preferably less than 40 μm. In one embodiment, a moldable or injectable composite porous material is provided comprising porous particles coated with calcium phosphate. The moldable material further comprises a carrier, and is made moldable, or injectable by the addition of a fluid. Unlike existing moldable materials, the present embodiment provides materials in which individual particles within the moldable material are coated with a layer of resorbable calcium phosphate. The layer of calcium phosphate preferably comprises hydroxyapatite.

The porous particles preferably have an average size in the range of about 250 μm to 20 mm for use as a moldable material, and preferably have an average size that is smaller than about 250 μm, and more preferably between about 45 μm to 250 μm, for use as an injectable material (for example, for use with a syringe). The porous particles preferably comprise a macroporous structure.

Porous particles may be obtained by producing a porous monolith followed by a grinding step for obtaining particles with a desired average size or size distribution. In a non-limiting example, a porous polymer monolith may be formed according to the methods disclosed in U.S. Pat. No. 6,472,210. More preferably, the polymer monolith further comprises calcium phosphate particles, as disclosed in U.S. Pat. No. 7,022,522. Preferably, the porous particles are resorbable for use in bone regeneration applications. The porous particles are coated with a layer of calcium phosphate, and more preferably, coated with a layer of hydroxyapatite, according to the embodiments disclosed above. Preferably, the particles are coated according to the above embodiments after having first ground a porous monolith into particles having a desired average size. By coating the particles after the grinding step instead of before the grinding step, all internal and external surfaces of the particles may be coated.

The carrier, which is mixed with the particles, is incorporated for forming a paste, putty or other moldable or injectable form when further combined with a liquid, as described below. The carrier may be provided in a solid phase, such as a powder, or a liquid or gelatinous phase, and need not infiltrate the pores of the porous particles upon mixing. The carrier preferably comprises a biocompatible and biodegradable natural or synthetic polymer, including but not limited to, sodium alginate, gelatin, carboxymethyl cellulose, lecithin, glycerol, sodium hyaluronate, and pluronic F127. The amount of carrier is preferably 10-20% (wt % based on the weight of the particles and the carrier), more preferably 10-15%, for moldable form, and 15-20% for injectable form.

The fluid mixed with the particles to form the moldable material may be selected from a wide range of compatible fluids, including, but not limited to, aqueous liquids such as water or more preferably sterilized water, physiological saline, and a patient's own blood or bone marrow aspirate. The mixing ratio is preferably in the range of approximately 1.5-3.0 ml fluid to 1.0 grams of particles and carrier to produce a moldable material, and approximately 3.0-5.0 ml fluid to 1.0 grams of particles and carrier to produce an injectable material.

In one embodiment, the material is provided in a kit comprising two or more components. For example, the coated particles and the carrier may be pre-mixed and provided as a single component. In yet another exemplary yet non-limiting embodiment, the kit may omit the fluid, as the fluid may be provided based on a patient sample rather than as an external kit component. The kit may further comprise one or more tools for use in injecting or molding the material.

Moldable porous material according to the above embodiments may be used for numerous clinical applications involving bone repair and regeneration. After implantation, new bone and blood vessels gradually grow into the spaces between the particles, while the particles and carrier are gradually resorbed. Eventually the newly formed bone tissue substantially replaces the particles and therefore repairs damaged bone tissue. Moldable materials as described above may be formed to any shapes (for example, by a surgeon) to fill in any irregular shapes of bony voids to achieve better bone healing. Injectable materials as described above may be delivered to the bone defects through a syringe with minimal invasion of patient's body.

In another embodiment, a composite porous guided bone regeneration (GBR) membrane is provided for bone healing and guided tissue regeneration applications. Bone healing is important in numerous clinical fields, including oral, maxillofacial, orthopedic and plastic surgery. The rapid invasion of fibrous connective tissue in bone defect during the healing, which can lead to the incomplete bone formation with low mechanical strength and cartilage-like tissue, has been considered as a major problem.

GBR membranes provide a physical barrier for creating a space around a defect, thereby preventing fibrous connective tissue invasion into the defect space and, thus, can promote bone healing. GBR membranes have widely been used as a simple therapy for bone healing until now and researchers have usually considered that the requirements of GBR membranes for successful outcome are as follows: mechanical strength to maintain a secluded space for bone regeneration, selective permeability to prevent fibrous connective tissue invasion but allow nutrient and oxygen supplies, adhesiveness between membrane and surrounding bone tissues to prevent movement of membrane, flexibility to provide surgical facility and prevent damage of surrounding tissues, and biodegradability which is not necessary second surgical procedure to remove membrane.

To fulfill these requirements, various materials, including natural and synthetic polymers, such as collagen, sodium alginate, expanded poly(tetrafluoro ethylene) (e-PTFE), polylactide, polyglycolide or poly(lactide-co-glycolide) (PLGA) and poly(L-lactic-co-ε-caprolactone), have been investigated. Among them, e-PTFE membranes have been most widely used. However, their non-degradability, because of which a second surgical procedure is necessary, possibly causing bone resorption, and brittleness, which can bring dehiscence of the soft tissues with exposure of the membrane and, thus, bacterial contamination, still remains as limitations, regardless of the good clinical results. The fast degradation and poor mechanical strength of natural polymers, and low permeability caused by hydrophobicity and brittleness of biodegradable synthetic polymers are also considered as critical problems for clinical applications.

In contrast to known GBR membranes, the present embodiment provides a coated porous material formed as a sheet and combined with a biocompatible and biodegradable film to produce a multi-layer membrane for guided bone regeneration application. Accordingly, a guided bone regeneration (GBR) membrane is provided based on the guided tissue regeneration (GTR) technique, comprising a polymer film having formed thereon a porous sheet comprising an internally coated porous material. The porous material, which is preferably macroporous, is internally coated with calcium phosphate according to the aforementioned embodiments. The composite porous membrane is preferable resorbable, and more preferably, both the polymer film and the porous sheet both comprise a common resorbable polymer. In a non-limiting example, a porous polymer sheet may be formed according to the methods disclosed in U.S. Pat. No. 6,472,210. More preferably, the porous polymer monolith further comprises calcium phosphate particles, as disclosed in U.S. Pat. No. 7,022,522. Preferably, the porous particles are resorbable for use in bone regeneration applications. The polymer film and the porous sheet preferably comprise poly(lactide-co-glycolide) (PLGA).

The porous sheet is preferably prepared to a thickness of approximately 0.5-2.0 mm, with transverse dimensions of approximately 10.0-30.0 mm. Such a size can be readily obtained, for example, by cutting a porous composite block, prepared as described in U.S. Pat. Nos. 7,022,522 and 6,472,210, with preferred pore size range of 200-800 μm. The coating of calcium phosphate is formed according to the aforementioned embodiments, and may be provided before or after cutting the porous monolith to a desired sheet size.

The polymer film is preferably formed from a biocompatible and biodegradable polymer solution. The film may be fabricated by dissolving a polymer in a solvent to form a solution of 15-35% (wt) concentration. The solvent may include, but is not limited to, acetone, chloroform, dichloromethane, ethyl acetate, and tetrahydrofuran. The polymer solution is cast to form a film, for example, using a glass or plastic slide. The coated porous composite sheet is then gently applied on the film surface when the majority of the solvent has evaporated, with a small amount of liquid solvent remaining to act as a liquid glue for adhering the porous sheet to the film. The prepared membrane is preferably maintained at room temperature for at least 24 hours for drying.

The following examples are presented to enable those skilled in the art to understand and to practice the present invention. They should not be considered as a limitation on the scope of the invention, but merely as being illustrative and representative thereof.

### EXAMPLES

### Example 1

### Preparation of Solution

Under stirring, chemicals were dissolved in 1 liter ddH₂O the order as listed in Table 1 to provide a calcifying solution. Each chemical was added in sequence after the previous chemical had completely dissolved. While the sequence below is preferred, those skilled in the art will appreciate that the order of the first three chemicals may be varied.

TABLE 1
Preferred Concentrations for Calcifying Solution

| Order | Chemical | Concentration Range (mM) |
|---|---|---|
| 1 | NaCl | 200.0-740.0 |
| 2 | CaCl₂•2H₂O | 7-14 |
| 3 | HCl | 5.0-15.0 |
| 4 | Na₂HPO₄ | 3.0-6.0 |
| 5 | NaHCO₃ | 4.0-20.0 |

The prepared solution preferably has a pH value ranging from 6.2 to 6.8 and should be used for coating within 30 minutes of the addition of NaHCO₃ (due to the rapid release of CO₂ following the addition of NaHCO₃). If preferred, the solution may be initially prepared without adding NaHCO₃ and could be kept at room temperature prior to adding NaHCO₃.

### Example 2

### Method of Coating Scaffold

PLGA/CaP composite macroporous materials were fabricated according to the method disclosed in U.S. Pat. No. 7,022,522 (Example 10), which is incorporated herein by reference in its entirety.

1.0 g of scaffold cylinders were weighed and put into a plastic mesh bag. Depending on the coating thickness required, 300-600 ml calcifying solution was measured into a 1 L beaker with a stirrer. The mesh bag was completely immersed in the solution and immobilized. The beaker was sealed by an aluminum foil and two small holes with 1.6 mm diameter were created by a 16 G needle. The beaker was then placed in a 37° C. water bath, where the material was incubated under constant stirring at a rate of 200-400 revolutions per minute.

The bath temperature and stirring rate were maintained over one day. The coated scaffold was removed from the mesh bag and rinsed 3 times by ddH₂O before being subsequently dried.

It was found that the coating thickness could be easily adjusted by changing the ratio of calcifying solution/coated substrate (volume/weight), or concentration of calcium and phosphate ions in the solution, and/or coating time.

### Example 3

### Characterization of Coating by X-Ray Diffraction (XRD) Analysis

The calcifying solution was kept at 37° C. under stirring for 24 hours, in the absence of a scaffold or other substrate material. The resultant precipitate was filtered, rinsed by ddH₂O and subsequently dried.

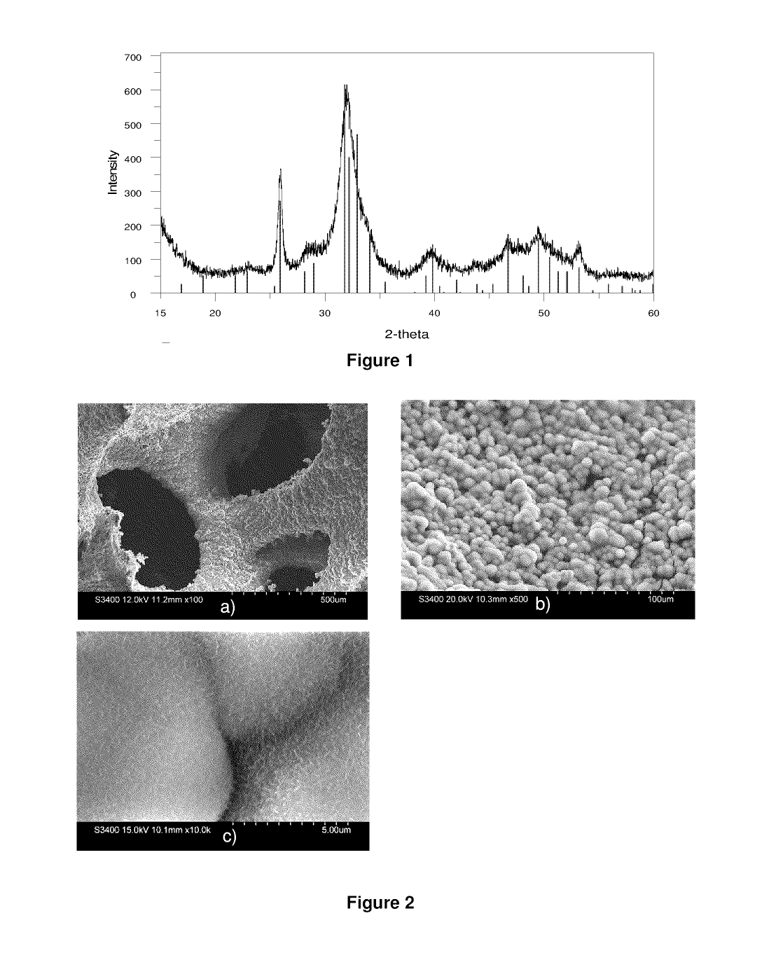

The produced white powder was collected and XRD analysis was conducted as shown in FIG. 1. The XRD patterns reveal that the product is composed of poorly crystalline hydroxyapatite (HA) similar to human bone mineral. Specifically, the peak at 25.81 2θ and between 31.7 and 33.1 2θ are characteristic of HA.

### Example 4

### Characterization of Coating by Scanning Electron Microscopy

A large cube of 20×20×15 mm³ of macroporous PLGA/CaP composite scaffold was coated by immersing the cube in 650 ml calcifying solution for one day. The coated sample was rinsed by ddH₂O and dried. The morphology and the thickness of the coating were evaluated by using scanning electron microscopy (SEM). A series of sample sheets of 2 mm in thickness were then prepared by cutting the scaffold in the middle part to expose different internal surfaces of the scaffold. SEM images in FIGS. 2(a-c) reveal that dense and uniform HAp layers are observed on all the surface of the scaffold, (shown in FIG. 2(a)) demonstrating a thorough coating of calcium phosphate on the internal scaffold surfaces, even though the scaffold size is too big for other conventional coating methods to achieve a satisfactory coating. The layers are composed of micrometer sized globules or spherules (visible in FIG. 2(b) and FIG. 2(c)). The coating has a thickness averaging between 1 to 10 microns.

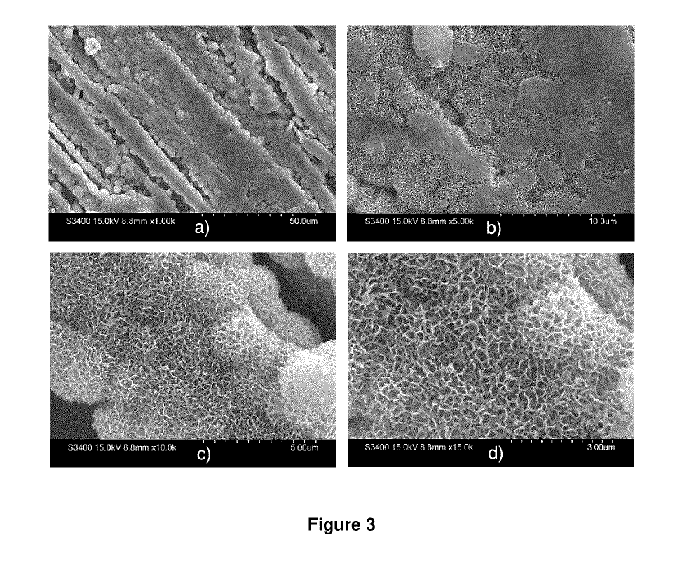

A polished polyaryletheretherketone (PEEK) polymer disk with a diameter of 15 mm and a thickness of 2 mm was coated by 50 ml calcifying solution for one day. The coated sample was rinsed by ddH₂O and dried. The sample was then examined by SEM. FIGS. 3(a)-(d) show that the polymer surface was completely coated by the apatite crystals.

### Example 5

### In-Vivo Histological Examination of Coated Implant

PLGA/CaP composite scaffold cylinders with a diameter of 2.1 mm and a length of 2-3 mm in length were coated by the method described above and irradiated for sterilization prior to implantation. The scaffolds were inserted into the hole at the distal end of the rat femur. Two weeks after the implantation, the rats were sacrificed and histological examination was performed by use of wax embedding and hematoxylin and eosin (HE) staining techniques (N=6).

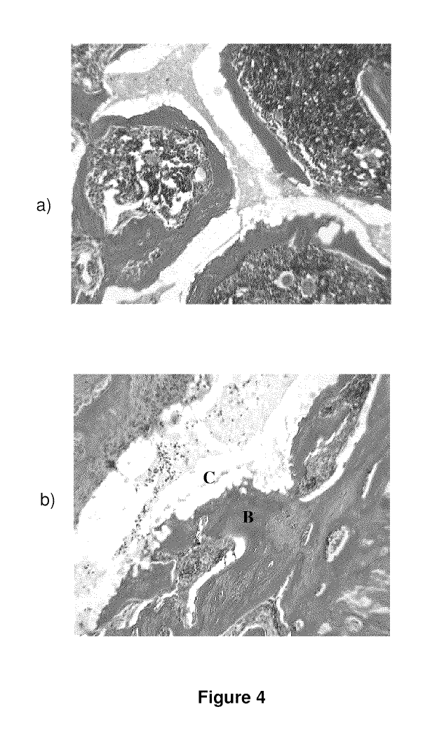

FIGS. 4(a) and 4(b) clearly showed that newly formed bone (B) directly contact the coating (C) on the scaffold surface (S) and grows along the outline of the coating. The crenellated morphology of bone at the interface that mirrored the globular morphology of the CaP coating was evidence that the bone formed was in direct contact with coating. The results demonstrate that the coated scaffold elicited excellent tissue responses by allowing new bone directly contact with the coating layers and expelling foreign body giant cells, thus eliminating the chronic inflammatory response usually associated with the tissue reaction to the underlying PLGA polymer.

### Example 6

### Preparation of Moldable/Injectable Porous Material

PLGA/CaP composite macroporous materials were fabricated according to the method disclosed in U.S. Pat. No. 7,022,522 (Example 10), which is incorporated herein by reference in its entirety. The materials were ground to small particles by a grinding machine and then sieved. The particles with a size range of 350 μM to 10 mm were collected for preparation of the moldable material. The particles with a size range of 45 μm to 200 μm were collected for making the injectable material.

The particles were coated respectively as described in Examples 1 and 2. The coated particles were left at room temperature at least 24 hours for drying.

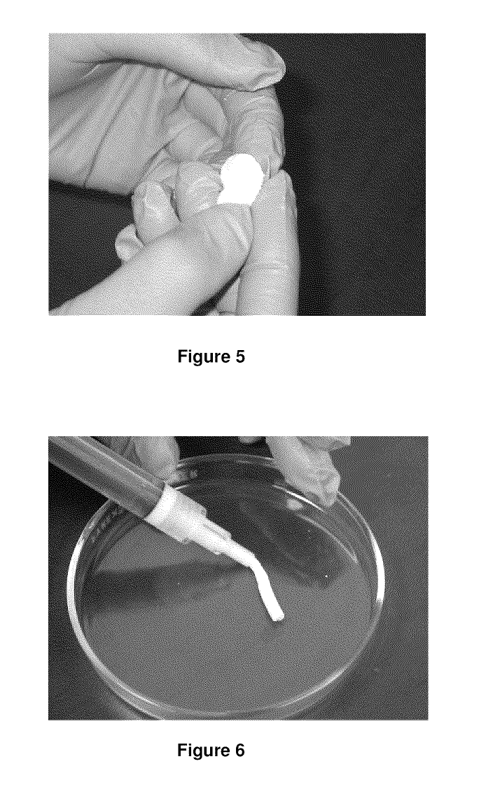

In one study, 1.0 gram of the particles having size between about 350 μm and 10 mm was mixed with 0.2 gram of sodium alginate powder to make a moldable material. Then the mixture was thoroughly mixed with 2.0 ml sterile water to form a moldable paste ready to fill any shapes of bone voids as shown in FIG. 5.

In a second study, 1.0 gram of the particles having a size between about 100 μm and 200 μm was mixed with 0.25 gram of carboxymethyl cellulose powder to make an injectable powder. The powder was thoroughly mixed with 4.0 ml sterile water to form a paste and then loaded into a 10 ml surgical syringe. The injectable material was therefore ready to be injected into bone defects as shown in FIG. 6.

### Example 7

### Fabrication of GBR Membrane Including Porous Layer Internally Coated with Calcium Phosphate

A composite porous material with a pore size within the range of 350-600 μm was fabricated according to methods disclosed in U.S. Pat. No. 7,022,522, and internally coated with a layer of calcium phosphate according to the aforementioned methods disclosed herein. The material was subsequently processed to a size of 1×20×20 mm, thereby forming a composite sheet comprising an internal porous network of pores coated with calcium phosphate.

A polymer film for supporting the composite sheet was fabricated as follows. 1.0 gram poly(lactide-co-glycolide) was dissolved in 5 ml dichloromethane to make a 20% (wt) polymer solution. The solution was then poured onto a glass slide to form a film. After approximately 3-5 minutes, when most of the solvent had evaporated and only a small fraction of the solvent remained, the composite sheet was placed on the film surface and gently pressed to ensure the sheet closely contact with the film. After drying at room temperature for 24 hours, the multilayer membrane was ready.

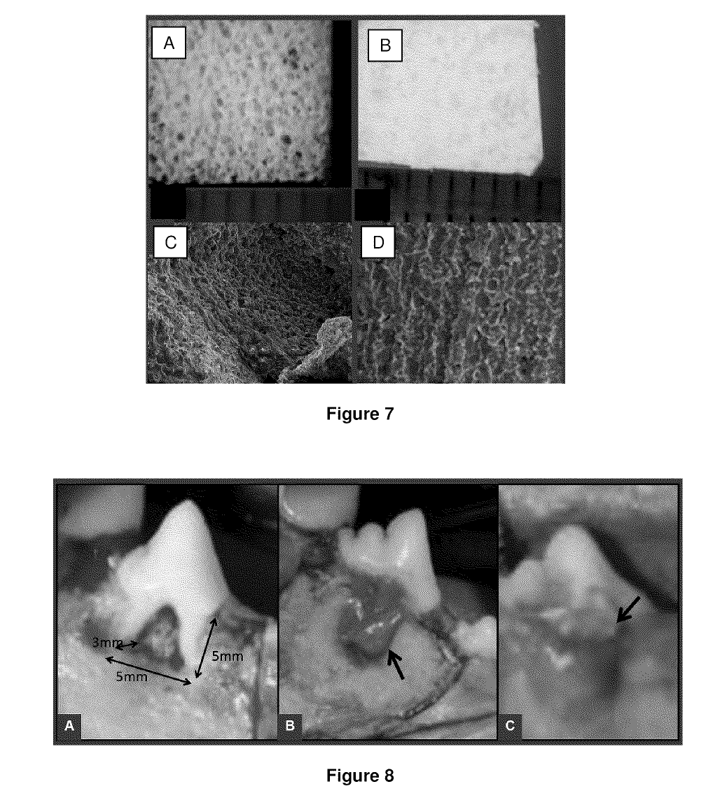

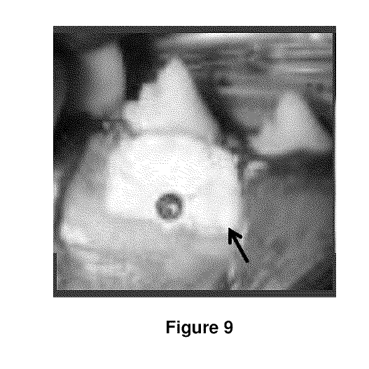

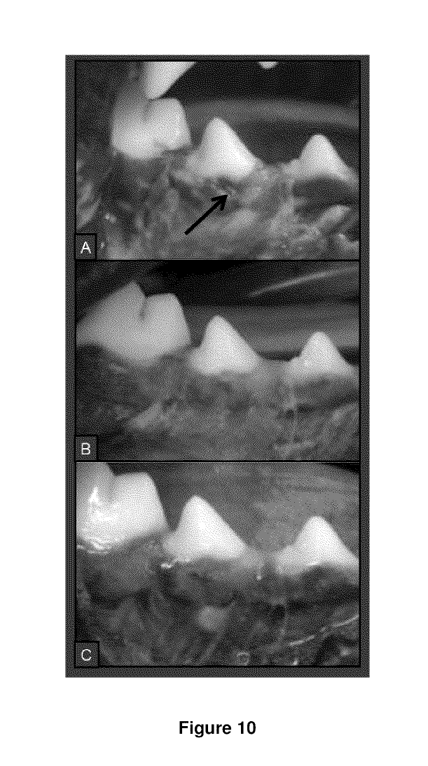

In order to assess the clinical utility of such composite membranes incorporating a coating of calcium phosphate, an experimental study was performed involving canine dental defects. Composite membranes were produced as described above, providing a porous sheet integrated with a PLGA polymer film. The porous sheet was formed from a composite porous scaffold (as described in U.S. Pat. No. 7,022,522 (Example 10)), which was internally coated with calcium phosphate according to the aforementioned embodiments. The membranes comprised two distinct surfaces: a porous surface, meant to face the defect (FIGS. 7(a) and (c)) and a flat surface (FIGS. 7 (b) and (d)).

Periodontal disease induction and treatment were performed in a three step routine¹⁰. A defect was created in the animals' premolars (FIG. 8(a)). Each of the 12 dogs had five defects, which corresponded to the five treatments. An impression material was used to induce the disease (FIGS. 8(b) and (c)). Prophylaxis was carried out 21 days later and after another 14 days, treatment using either OFD (Group A) or GTR was performed using: PLGA+CaP (Group B; FIG. 10(a)), or titanium (Group E) membranes.

The animals were evaluated for signs of bleeding, edema, purulent secretion, gingival recession (GR) and dehiscence (Dh) everyday during the first 14 days following surgery. GR and clinical attachment level (CAL) were evaluated at 30, 60, 90 and 120 days, when radiographs were also obtained. At 60 days PO, titanium membranes were removed, and subsequent healing monitored. Six animals were euthanized at 60 days after surgery and the others at 120 days. Biopsies were collected at both time-points. Bone volume/total volume (BV/TV), trabeculae number (TN), trabecular thickness (TT) and trabecular separation (TS) were evaluated using MicroCT. To analyse data, ANOVA followed by Tukey test was used (p<0.05).

Healing occurred uneventfully. Although Dh and GR were observed in all groups, differences were seen in the evolution of healing: while GR occurred for no longer than 2 days in group B followed by uneventful healing, it progressed in all of the other groups. Two animals had to be excluded for reasons not related to the project.

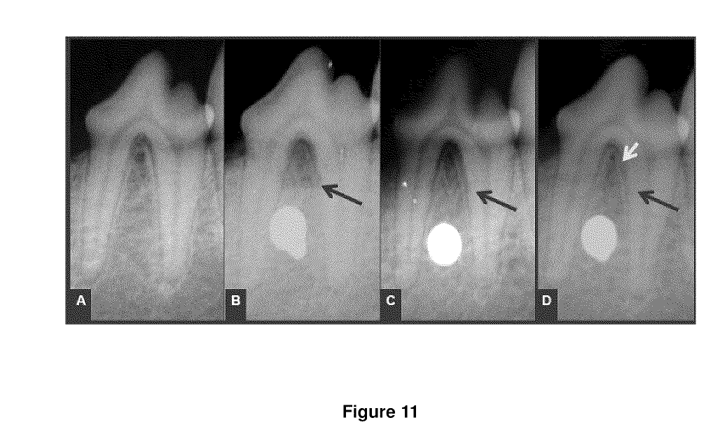

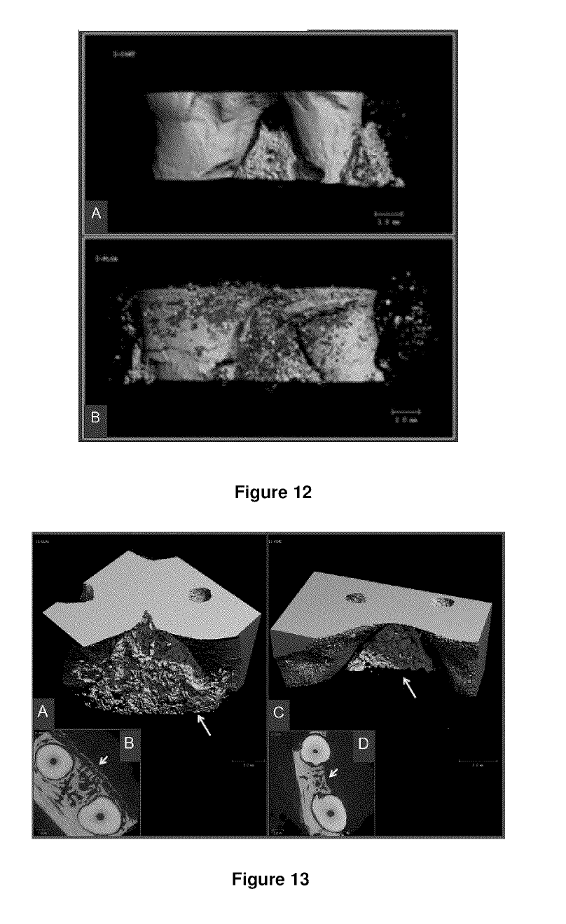

The mean CAL was within normal physiological parameters (under 3 mm) by 60 days only in group B (FIG. 13). Class III furcation defects developed in 6 (Group A), and 3 (Group E) treated defects. Radiographs showed more bone in group B already by 60 days and lamina dura in the furcation by 120 days (FIG. 14). MicroCT results confirmed: BV/TV, TN, TT and TS were significantly greater in group B than in all of the other groups both at 60 and 120 day PO, p ranged from 0.0017 to 0.0349 (FIGS. 11, 12 and 13). The data suggests that the PLGA and coated CaP composite membrane treatment is a promising alternative to OFD.

The foregoing description of the preferred embodiments of the invention has been presented to illustrate the principles of the invention and not to limit the invention to the particular embodiment illustrated. It is intended that the scope of the invention be defined by all of the embodiments encompassed within the following claims and their equivalents.

### REFERENCES

1. Kim H M, Takadama H, Miyaji F, Kokubo T, Nishiguchi S, Nakamura T. Formation of bioactive functionally graded structure on Ti-6Al-4V alloy by chemical surface treatment. J Mater Sci Mater Med 2000; 11: 555-559.
2. Kokubo T, Kim H M, Kawashita M, Nakamura T. Bioactive metals: preparation and properties. J Mater Sci Mater Med 2004; 15: 99-107.
3. Oyane A, Onuma K, Ito A, Kim H M, Kokubo T, Nakamura T. Formation and growth of clusters in conventional and new kinds of simulated body fluids. J Biomed Mater Res 2003; 64A: 339-348.
4. Habibovic P, Barrere F, van Blitterswijk C A, de Groot K, Layrolle P. Biomimetic apatite coating on metal implants. J Am Ceram Soc 2002; 85: 517-522.
5. Barrere F, van Blitterswijk C A, de Groot K, Layrolle P. Influence of ionic strength and carbonate on the Ca-P coating formation from SBF×5 solution. Biomaterials 2002; 23: 1921-1930.
6. Barrere F, van Blitterswijk C A, de Groot K, Layrolle P. Nucleation of biomimetic Ca-P coatings on Ti6Al4V from SBF×5 solution: influence of magnesium. Biomaterials 2002; 23: 2211-2220.
7. Barrere F, van der Valk C M, Dalmeijer R A J, van Blitterswijk C A, de Groot K, Layrolle P. In vitro and in vivo degradation of biomimetic octacalcium phosphate and carbonate apatite coatings on titanium implants. J Biomed Mater Res 2003; 64A: 378-387.
8. Barrere F, van der Valk C M, Meijer G, Dalmeijer R A J, de Groot K, Layrolle P. Osteointegration of biomimetic apatite coating applied onto dense and porous metal implants in femurs of goats. J. Biomed Mater Res Part B: Appl Biomater 2003; 67B: 655-665.
9. Tas A C and Bhaduri S B, Rapid coating of Ti6Al4V at room temperature with a calcium phosphate solution similar to 10× simulated body fluid. J. Mater. Res. 2004; 19(9):2742-2749.
10. Roriz V M, Souza S L S, Taba Jr M, Palioto D B, Grisi M F M. J Periodontol 2006; 77:490-497.

1. A method of forming a calcium phosphate coating on internal surface of a porous material, said method comprising the steps of:
providing an aqueous solution comprising calcium ions, phosphate ions, and carbonate ions, wherein said aqueous solution has a temperature less than approximately 100° C. and an initial pH in a range of approximately 6.0 to 7.5;
contacting said porous material with said solution; and
agitating said solution while forming said calcium phosphate coating on said internal surface of said porous material.

2. The method according to claim 1 wherein said solution is agitated at a speed of approximately 50-1000 revolutions per minute.

3. The method according to claim 1 wherein said solution is agitated at a speed of approximately 200-400 revolutions per minute.

4. The method according to claim 1 wherein said step of agitating said solution increases a rate of change of said pH of said solution by increasing a rate of extraction of carbon dioxide gas from said solution to an atmosphere above said solution, and wherein said rate of change of pH of said solution is selected by controlling said step of agitating of said solution.

5. The method according to claim 1 wherein said carbonate ions are provided by adding a quantity of sodium bicarbonate to said solution.

6. The method according to claim 5 wherein said carbonate ions are present with a concentration in the range of approximately 1-50 mM.

7. The method according to claim 1 wherein said calcium ions are present with a concentration in the range of approximately 1-50 mM and said phosphate ions are present with a concentration in the range of approximately 1 to 25 mM.

8. The method according to claim 1 wherein said temperature of said solution is controlled within a range of approximately 20° C. to 50° C.

9. The method according to claim 1 wherein said aqueous solution further comprises additional ionic species selected from the group consisting of sodium, magnesium, chlorine, potassium, sulfate, silicate and mixtures thereof.

10. The method according to claim 9 wherein said sodium ions are present with a concentration in the range of approximately 100 to 1000 mM, said chlorine ions are present with a concentration in the range of approximately 100 to 1000 mM said potassium ions are present with a concentration in the range of approximately 1 to 10 mM, said magnesium ions are present with a concentration in the range of approximately 0.1 to 10 mM.

11. The method according to claim 1 wherein a thickness of said calcium phosphate coating is selected by controlling a parameter selected from the group consisting of temperature, mixing rate, concentrations of ionic species, and any combination thereof.

12. The method according to claim 1 wherein said step of agitating said solution is performed until a thickness of said calcium phosphate coating is obtained in the range of approximately 0.5 to 50 microns.

13. The method according to claim 1 wherein said aqueous solution further comprises a bioactive material and said bioactive material is incorporated into said calcium phosphate coating.

14. The method according to claim 1 wherein said porous material comprises a connected network of macropores.

15. The method according to claim 14 wherein an average diameter of said macropores is greater than approximately 200 microns.

16. The method according to claim 1 wherein said porous material comprises a composite material formed of a macroporous polymer scaffold and calcium phosphate particles.

17. The method according to claim 16 wherein said macroporous polymer scaffold comprises essentially non-membraneous pore walls, said pore walls consisting of microporous polymer struts defining macropores which are interconnected by macroporous passageways, said microporous polymer struts containing calcium phosphate particles dispersed therethrough and a binding agent for binding said calcium phosphate particles to a polymer making up said macroporous polymer scaffold, microporous passageways extending through said microporous polymer struts so that macropores on either side of a given microporous polymer strut are in communication through said given microporous polymer strut.

18. The method according to claim 16 wherein said macroporous polymer scaffold comprises macropores a mean diameter in a range from about 0.5 to about 3.5 mm, and said macroporous polymer scaffold has a porosity of at least 50%.

19. The method according to claim 1 wherein said porous material comprises a material with a porous surface layer coating a solid support.

20. The method according to claim 19 wherein said material with a porous surface layer comprises one of a beaded substrate and a porous undercut.

21. The method according to claim 1 wherein said solution is provided in a vessel comprising an opening with a size selected to obtain a desired rate of change of said pH.

22. The method according to claim 21 wherein a ratio of a surface area of an interface between said solution and an atmosphere above said solution to an area of said opening is in the range of approximately 2000-5000.

23. The method according to claim 1 further comprising the step of adding of a concentration of hydrochloric acid to said solution prior to contacting said porous material with said solution.

24. The method according to claim 23 wherein said concentration of hydrochloric acid in said solution is in the range of approximately 1-25 mM.

25. The method according to claim 1 wherein said calcium phosphate coating is hydroxyapatite.

26. The method according to claim 1 wherein said porous material comprises an internally connected porous network, said network defined substantially throughout said material.

27. The method according to claim 1 wherein said porous material comprises a plurality of porous particles.

28. The method according to claim 27 wherein said porous particles are obtained by grinding a monolithic porous structure.

29. The method according to claim 27 wherein an average size of said porous particles is between approximately 250 microns and 20 mm.

30. The method according to claim 27 wherein an average size of said porous particles is between approximately 45 microns and 250 microns.

31. The method according to claim 27 further comprising the step of separating said porous particles coated with calcium phosphate from said solution and mixing said porous particles coated with calcium phosphate with a carrier.

32. The method according to claim 31 wherein said carrier is selected from the group consisting of sodium alginate, gelatin, carboxymethyl cellulose, lecithin, glycerol, sodium hyaluronate, and pluronic F127.

33. The method according to claim 31 further comprising the step of forming a moldable porous material by adding a fluid to said porous particles coated with calcium phosphate and said carrier.

34. The method according to claim 31 wherein said carrier is provided with a weight percentage of approximately 10-20%.

35. The method according to claim 33 wherein said fluid is selected from the group consisting of water, sterilized water, physiological saline, blood and bone marrow aspirate.

36. The method according to claim 33 wherein approximately 1.5-3.0 ml of fluid are provided for each 1.0 gram of particles.

37. The method according to claim 1 wherein said porous material is formed as a sheet, said method further comprising the steps of:
forming a polymer film by casting a polymer solution comprising a polymer dissolved in a solvent; and
adhering said sheet to a surface of said polymer film.

38. The method according to claim 37 wherein said step of adhering said sheet to said surface of said film comprises the step of contacting said sheet with said surface before said film has fully solidified.

39. The method according to claim 37 wherein said polymer comprises one of poly(lactide-co-glycolide) and polylactide.

40. The method according to claim 37 wherein said solvent is selected from the group consisting of acetone, chloroform, dichloromethane, ethyl acetate, and tetrahydrofuran.

41. The method according to claim 37 wherein said porous material and said polymer film comprise a common polymer.

42. A material comprising an internally connected porous network, said porous network defined substantially throughout said material, wherein pores forming said porous network are coated with a calcium phosphate layer.

43. The material according to claim 42 wherein a thickness of said calcium phosphate layer is in a range of approximately 0.5 to 50 microns.

44. The material according to claim 42 wherein said layer further comprises a bioactive material.

45. The material according to claim 42 wherein said porous network comprises a connected network of macropores.

46. The material according to claim 45 wherein an average diameter of said macropores is greater than approximately 200 microns.

47. The material according to claim 42 wherein said internally connected porous network comprises a composite material formed of a macroporous polymer scaffold and calcium phosphate particles.

48. The material according to claim 47 wherein said macroporous polymer scaffold comprises essentially non-membraneous pore walls, said pore walls consisting of microporous polymer struts defining macropores which are interconnected by macroporous passageways, said microporous polymer struts containing calcium phosphate particles dispersed therethrough and a binding agent for binding said calcium phosphate particles to a polymer making up said
macroporous polymer scaffold, microporous passageways extending through said microporous polymer struts so that macropores on either side of a given microporous polymer strut are in communication through said given microporous polymer strut.

49. The material according to claim 47 wherein said macroporous polymer scaffold comprises with macropores a mean diameter in a range from about 0.5 to about 3.5 mm, and said macroporous polymer scaffold has a porosity of at least 50%.

50. The material according to claim 42 wherein said calcium phosphate layer is hydroxyapatite.

51. A composite porous membrane comprising:
a sheet comprising a material according to claim 42; and
a polymer film,
wherein said sheet is adhered to a surface of said polymer film.

52. The membrane according to claim 51 wherein said polymer comprises one of poly(lactide-co-glycolide) and polylactide.

53. The membrane according to claim 51 wherein said material and said polymer film comprise a common polymer.

54. A mixture for forming a moldable porous material, said mixture comprising:
a plurality of porous particles, each said porous particle comprising a calcium phosphate coated porous material according to claim 42; and
a carrier, wherein an addition of a fluid to said mixture forms said moldable porous material.

55. The mixture according to claim 54 wherein an average size of said porous particles is between approximately 250 microns and 20 mm.

56. The mixture according to claim 54 wherein an average size of said porous particles is between approximately 45 microns and 250 microns.

57. The mixture according to claim 54 wherein said carrier is selected from the group consisting of sodium alginate, gelatin, carboxymethyl cellulose, lecithin, glycerol, sodium hyaluronate, and pluronic F127.

58. The mixture according to claim 54 wherein a weight percentage of said carrier is approximately 10-20%.

59. The mixture according to claim 54 further comprising said fluid.

60. The mixture according to claim 59 wherein said fluid is selected from the group consisting of water, sterilized water, physiological saline, blood and bone marrow aspirate.

61. The mixture according to claim 59 wherein a ratio of a volume of said fluid to a weight of said particles and carrier is approximately 1.5-3.0 ml per 1.0.

62. A method of forming a calcium phosphate coating on internal surface of a porous material comprising a composite material formed of a macroporous polymer scaffold and calcium phosphate particles, said method comprising the steps of:
providing an aqueous solution comprising calcium ions, phosphate ions, and carbonate ions, wherein said aqueous solution has a temperature in a range of approximately 20° C.-50° C. and an initial pH in a range of approximately 6.0-7.5;
contacting said porous material with said solution; and
stirring said solution at a speed of approximately 200-400 revolutions per minute while forming said calcium phosphate coating on said internal surface of said porous material.

63. The method according to claim 62 where said solution comprises NaCl with a concentration in a range of approximately 200-800 mM, CaCl2.2H2O with a concentration in a range of approximately 7-14 mM, HCl with a concentration in a range of approximately 5-15 mM, Na2HPO4 with a concentration in a range of approximately 3-6 mM, and NaHCO3 with a concentration in a range of approximately 4-20 mM.

64. A material comprising an internally connected porous network, wherein pores forming said porous network are coated with a calcium phosphate layer by a method according to claim 1.
